(19) United States
(12) Patent Application Publication
(10) Pub. No.: US 2026/0302675 A1
(43) Pub. Date: Oct. 1, 2026

(54) FIRST CONNECTOR AND CONNECTOR PAIR

(71) Applicant: IRISO ELECTRONICS CO., LTD., Yokohama-shi (JP)

(72) Inventors: Takashi SATO, Yokohama-shi (JP); Hideki SHIODA, Yokohama-shi (JP)

(21) Appl. No.: 19/578,974

(22) Filed: Mar. 26, 2026

(30) Foreign Application Priority Data
Mar. 28, 2025 (JP) 2025-057262

(51) Int. Cl. H01R 13/422; H01R 12/71

(52) U.S. Cl. CPC H01R 13/422; H01R 12/716

(57) ABSTRACT

A first terminal 10 of a first connector 100 includes a mating-side first held portion 14 and a first contact portion 16 that electrically contacts a connection target 200. The mating-side first held portion 14 is held in a first mating housing 50 as a result of being press-fitted in a predetermined press-fitting direction into it. The mating-side first held portion 14 is positioned in a different position from the first contact portion 16 in a first perpendicular direction of the mating-side first held portion 14, which is a specific direction out of directions perpendicular to the press-fitting direction of the mating-side first held portion 14, and has a range overlapping the first contact portion 16 in the press-fitting direction of the mating-side first held portion 14.

### BACKGROUND

### Technical Field

This disclosure relates to a first connector and a connector pair.

### Related Art

Japanese Patent No. 5849166 discloses a connector. A terminal of the connector is inserted into a housing (mating housing) along a terminal insertion direction (Z direction) and has a base end portion that is fixed to a bottom wall of the housing. The base end portion opposes the bottom wall of the housing in a width direction (X direction) and a thickness direction (Y direction), which are two directions that are orthogonal to the terminal insertion direction (Z direction) and are orthogonal to each other. A first contact portion of the terminal is positioned nearer to a distal end than to the base end portion.

### SUMMARY

In this connector, the range in which the bottom wall of the housing and the base end portion oppose each other in the width direction (X direction) and the thickness direction (Y direction) is short in the terminal insertion direction (Z direction). For that reason, when the terminal is inserted, the base end portion tends to tilt greatly from its normal attitude. As a result, the first contact portion may be disposed shifted from its normal attitude in the housing.

If, to address this, the base end portion and the bottom wall of the housing are lengthened in the terminal insertion direction (Z direction), the terminal becomes larger in the terminal insertion direction (Z direction), so the connector ends up increasing in size.

Furthermore, if the base end portion and the bottom wall of the housing are lengthened in the terminal insertion direction (Z direction) while maintaining the overall size of the terminal in the terminal insertion direction (Z direction), the first contact portion becomes shorter in the terminal insertion direction (Z direction), thereby reducing the reliability of the connection of the connector. Particularly in a low-profile connector, the length of the first contact portion is inherently short, so if the base end portion is lengthened and the first contact portion is shortened, the connection between the first contact portion and a counterpart connector may end up being broken due to vibration or shock.

It is an object of this disclosure to stabilize, in a connector in which a terminal is held by being press-fitted into a mating housing, the attitude of the terminal relative to the mating housing while preventing an increase in the size of the connector in the press-fitting direction.

A first connector pertaining to a first aspect includes: a first mating housing that mates with a connection target; and a first terminal, wherein the first terminal includes a first held portion that is held in the first mating housing, a first contact portion that electrically contacts the connection target, and a first coupling portion that couples the first held portion and the first contact portion to each other, the first held portion is held in the first mating housing as a result of being press-fitted in a predetermined press-fitting direction into the first mating housing, and the first held portion is positioned in a different position from the first contact portion in a first perpendicular direction of the first held portion, which is a specific direction out of directions perpendicular to the press-fitting direction of the first held portion, and has a range overlapping the first contact portion in the press-fitting direction of the first held portion.

This aspect relates to the first connector. The first connector includes the first mating housing, which mates with the connection target, and the first terminal. The first terminal includes the first held portion that is held in the first mating housing, the first contact portion that electrically contacts the connection target, and the first coupling portion that couples the first held portion and the first contact portion to each other. The first held portion is held in the first mating housing as a result of being press-fitted in a predetermined press-fitting direction into the first mating housing.

In this connection, from the standpoint of allowing the first terminal to be held in the correct attitude in the first mating housing, it is preferable to increase the dimension, in the press-fitting direction, of the first held portion that is press-fitted into the first mating housing. However, when the dimension of the first held portion in the press-fitting direction is increased, the dimension of the entire first connector in the press-fitting direction ends up increasing.

Thus, in this aspect, the first held portion is positioned in a different position from the first contact portion in the first perpendicular direction of the first held portion, which is a specific direction out of directions perpendicular to the press-fitting direction of the first held portion, and has a range overlapping the first contact portion in the press-fitting direction of the first held portion.

For this reason, compared with an aspect where the first held portion does not have a range overlapping the first contact portion in the press-fitting direction of the first held portion (see Japanese Patent No. 5849166), the dimension of the first held portion in the press-fitting direction can be increased while preventing an increase in the size of the first connector in the press-fitting direction of the first held portion, and the attitude of the first terminal relative to the first mating housing can be stabilized.

It will be noted that although in the embodiment described below the first mating housing is configured to be movable relative to a first attachment target to which the first connector becomes attached, this aspect is not limited thereto.

Furthermore, although in the embodiment described below the first terminal is a power terminal, this aspect is not limited thereto. The first terminal may also be a signal terminal.

Furthermore, although in the embodiment described below the first connector includes a signal terminal in addition to a power terminal serving as the first terminal, this aspect is not limited thereto.

Furthermore, although in the embodiment described below the first coupling portion couples press-fitting direction end portions of the first held portion and the first contact portion to each other, this aspect is not limited thereto.

Furthermore, although in the embodiment described below the first contact portion is not press-fitted into the mating housing, this aspect is not limited thereto.

Furthermore, although in the embodiment described below, the first coupling portion is not press-fitted into the mating housing, this aspect is not limited thereto.

A first connector pertaining to a second aspect is the first aspect, wherein the first mating housing includes a first holding portion that holds the first held portion, and the first holding portion includes a one-side proximal surface that is positioned proximal to one thickness direction side of the first held portion and an other-side proximal surface that is positioned proximal to the other thickness direction side of the first held portion.

In this aspect, the first mating housing includes the first holding portion that holds the first held portion.

Here, the first holding portion includes the one-side proximal surface that is positioned proximal to one thickness direction side of the first held portion and the other-side proximal surface that is positioned proximal to the other thickness direction side of the first held portion.

For this reason, the first held portion can be inhibited from shifting from its appropriate position in the thickness direction of the first held portion.

It will be noted that although in the embodiment described below the thickness direction of the first held portion is parallel to the first perpendicular direction, this aspect is not limited thereto.

A first connector pertaining to a third aspect is the first or the second aspect, wherein the first contact portion is not press-fitted into the first mating housing.

In this connection, if the first contact portion is press-fitted into the first mating housing, shavings from the first mating housing may stick to the first contact portion and cause a conduction failure.

Thus, in this aspect, the first contact portion is not press-fitted into the first mating housing.

For this reason, the occurrence of a conduction failure caused by shavings from the first mating housing sticking to the first contact portion can be inhibited.

A first connector pertaining to a fourth aspect is any of the first to the third aspects, wherein the first coupling portion is configured to contact the connection target before the first contact portion does when the first connector and the connection target are connected to each other.

In this aspect, the first coupling portion is configured to contact the connection target before the first contact portion does when the first connector and the connection target are connected to each other.

For this reason, the first coupling portion can be made to function as a part that guides the part of the connection target that contacts the first contact portion when the first connector and the connection target are connected to each other.

A first connector pertaining to a fifth aspect is any of the first to the fourth aspects, wherein the first mating housing includes a first housing space that houses the first held portion and the first contact portion, and the first coupling portion is configured to be housed in the first housing space before the first held portion and the first contact portion are when the first held portion is press-fitted into the first mating housing.

In this aspect, the first mating housing includes the first housing space that houses the first held portion and the first contact portion.

Here, the first coupling portion is configured to be housed in the first housing space before the first held portion and the first contact portion are when the first held portion is press-fitted into the first mating housing.

For this reason, the first coupling portion can be made to function as a part that guides the first held portion and the first contact portion of the first terminal to the first housing space when the first terminal is press-fitted into the first mating housing.

It will be noted that although in an embodiment described later the first coupling portion includes a bent surface that is inclined relative to a first direction, this aspect is not limited thereto.

A first connector pertaining to a sixth aspect is any of the first to the fifth aspects, wherein the first contact portion is configured so that the connection target contacts the first contact portion from one thickness direction side of the first contact portion, and the first connector includes a regulating portion that regulates the first contact portion from being displaced to the other side in the thickness direction.

In this aspect, the first contact portion is configured so that the connection target contacts the first contact portion from one thickness direction side of the first contact portion.

Here, the first connector includes the regulating portion that regulates the first contact portion from being displaced to the other side in the thickness direction.

For this reason, a reduction in contact pressure caused by the first contact portion being displaced to the other side in the thickness direction can be inhibited.

It will be noted that although in the embodiment described below the thickness direction of the first contact portion is parallel to the first perpendicular direction, this aspect is not limited thereto.

A first connector pertaining to a seventh aspect is the sixth aspect, wherein the regulating portion includes a pair of regulating walls that regulate the first contact portion from being displaced to the other side in the thickness direction by contacting both width direction end portions of the first contact portion.

In this aspect, the regulating portion includes the pair of regulating walls that regulate the first contact portion from being displaced to the other side in the thickness direction by contacting both width direction end portions of the first contact portion.

For this reason, displacement of the first contact portion can be reliably regulated.

It will be noted that although in the embodiment described below, when a direction perpendicular to both the press-fitting direction and the first perpendicular direction is called a second perpendicular direction, the width direction of the first contact portion is parallel to the second perpendicular direction, this aspect is not limited thereto.

A first connector pertaining to an eighth aspect is the seventh aspect, wherein the pair of regulating walls are configured so that the first coupling portion can pass through a space between the pair of regulating walls when the first held portion is press-fitted into the first mating housing.

In this aspect, the pair of regulating walls are configured so that the first coupling portion can pass through the space between the pair of regulating walls when the first held portion is press-fitted into the first mating housing.

For this reason, when the first held portion is press-fitted into the first mating housing, the first coupling portion can be passed through the space between the pair of regulating walls.

A first connector pertaining to a ninth aspect is any of the first to the eighth aspects, wherein the first contact portion is not press-fitted into the first mating housing, the first contact portion is configured so that the connection target contacts the first contact portion from one thickness direction side of the first contact portion, and the first connector includes a regulating portion that regulates the first contact portion from being displaced to the other side in the thickness direction.

According to this aspect, the occurrence of a conduction failure caused by shavings from the first mating housing sticking to the first contact portion can be inhibited, and a reduction in contact pressure caused by the first contact portion being displaced to the other side in the thickness direction can be inhibited.

A first connector pertaining to a tenth aspect is any of the first to the ninth aspects, wherein the first contact portion is configured to not be substantially displaced.

In this aspect, the first contact portion is configured to not be substantially displaced.

For this reason, it is easy to control the contact pressure.

A first connector pertaining to an eleventh aspect is any of the first to the tenth aspects, wherein the first coupling portion includes bent portions that are bent in its thickness direction, and the first connector includes a springback prevention portion that prevents springback of the bent portions by contacting a part of the first terminal.

In this aspect, the first coupling portion includes the bent portions that are bent in its thickness direction.

Here, the first connector includes the springback prevention portion that prevents springback of the bent portions by contacting a part of the first terminal.

For this reason, springback of the bent portions of the first coupling portion can be prevented.

It will be noted that although in the embodiment described below the springback prevention portion is provided in the first mating housing, this aspect is not limited thereto.

Furthermore, although in the embodiment described below the “part of the first terminal” that the springback prevention portion contacts is a part of the first contact portion, this aspect is not limited thereto. The “part of the first terminal” that the springback prevention portion contacts may be a part other than the first contact portion.

A first connector pertaining to a twelfth aspect is any of the first to the eleventh aspects, wherein the first mating housing is configured to be movable relative to a first attachment target to which the first connector becomes attached.

In this aspect, the first mating housing is configured to be movable relative to the first attachment target to which the first connector becomes attached.

For this reason, positional shifting between the first attachment target and the connection target can be absorbed.

It will be noted that although in the embodiment described below the first connector includes a housing (a first fixed housing) that is fixed to the first attachment target, this aspect is not limited thereto.

A first connector pertaining to a thirteenth aspect is the twelfth aspect, wherein the first connector includes a first fixed housing that is fixed to the first attachment target to which the first connector becomes attached, the first terminal includes a mating-side first held portion serving as the first held portion, a fixed-side first held portion that is held in the first fixed housing, and a first spring portion that is provided between the mating-side first held portion and the fixed-side first held portion, and the fixed-side first held portion has a range overlapping the first contact portion in the press-fitting direction.

In this aspect, the first connector includes the first fixed housing that is fixed to the first attachment target to which the first connector becomes attached. The first terminal includes the mating-side first held portion serving as the first held portion, the fixed-side first held portion that is held in the first fixed housing, and the first spring portion that is provided between the mating-side first held portion and the fixed-side first held portion.

Here, the fixed-side first held portion has a range overlapping the first contact portion in the press-fitting direction.

For this reason, compared with an aspect where the fixed-side first held portion does not have a range overlapping the first contact portion in the press-fitting direction, an increase in the dimension of the first connector in the press-fitting direction can be prevented.

It will be noted that although in the embodiment described below the fixed-side first held portion is held in the first fixed housing as a result of being press-fitted into the first fixed housing, this aspect is not limited thereto.

A first connector pertaining to a fourteenth aspect is any of the first to the thirteenth aspects, wherein the first connector includes a second terminal, the second terminal includes a second held portion that is held in the first mating housing, a second contact portion that electrically contacts the connection target, and a second coupling portion that couples the second held portion and the second contact portion to each other, the second held portion is held in the first mating housing as a result of being press-fitted in a predetermined press-fitting direction into the first mating housing, the press-fitting direction of the second held portion is parallel to the press-fitting direction of the first held portion, and the second held portion does not have a range overlapping the second contact portion in the press-fitting direction of the second held portion.

In this aspect, the first connector includes the second terminal. The second terminal includes the second held portion that is held in the first mating housing, the second contact portion that electrically contacts the connection target, and the second coupling portion that couples the second held portion and the second contact portion to each other. The second held portion is held in the first mating housing as a result of being press-fitted in a predetermined press-fitting direction into the first mating housing. The press-fitting direction of the second held portion is parallel to the press-fitting direction of the first held portion.

Here, the second held portion is positioned in the same position as the second contact portion in a direction perpendicular to the press-fitting direction of the second held portion and does not have a range overlapping the second contact portion in the press-fitting direction of the second held portion.

For this reason, the electrical path resulting from the second terminal is easily made into a path with few detours. As a result, the first connector suitable for when the second terminal is used as a signal terminal can be realized.

It will be noted that although in the embodiment described below the thickness of the first terminal is greater than the thickness of the second terminal, this aspect is not limited thereto.

Furthermore, although in the embodiment described below the press-fitting direction of the second held portion is the same direction as the press-fitting direction of the first held portion, this aspect is not limited thereto. The press-fitting direction of the second held portion may be the opposite direction of the press-fitting direction of the first held portion.

Furthermore, although in the embodiment described below the second held portion is positioned in the same position as the second contact portion in a direction perpendicular to the press-fitting direction of the second held portion, this aspect is not limited thereto.

A first connector pertaining to a fifteenth aspect is the fourteenth aspect, wherein the thickness of the first terminal is greater than the thickness of the second terminal.

In this aspect, the thickness of the first terminal is greater than the thickness of the second terminal.

For this reason, the first connector suitable for when the first terminal is used as a power terminal can be realized.

A connector pair pertaining to a sixteenth aspect includes the first connector pertaining to any of the first to the fifteenth aspects and a second connector serving as the connection target.

This aspect relates to the connector pair including the first connector and the second connector serving as the connection target.

A connector pair pertaining to a seventeenth aspect is the sixteenth aspect, wherein the second connector includes a second mating housing, which mates with the first mating housing, and a third terminal, the third terminal includes a third held portion that is held in the second mating housing, a third contact portion that electrically contacts the first terminal, and a third coupling portion that couples the third held portion and the third contact portion to each other, the third held portion is held in the second mating housing as a result of being press-fitted in a predetermined press-fitting direction into the second mating housing, and the third held portion is positioned in a different position from the third contact portion in a first perpendicular direction of the third held portion, which is a specific direction out of directions perpendicular to the press-fitting direction of the third held portion, and has a range overlapping the third contact portion in the press-fitting direction of the third held portion.

In this aspect, the second connector includes the second mating housing, which mates with the first mating housing, and the third terminal. The third terminal includes the third held portion that is held in the second mating housing, the third contact portion that electrically contacts the first terminal, and the third coupling portion that couples the third held portion and the third contact portion to each other. The third held portion is held in the second mating housing as a result of being press-fitted in a predetermined press-fitting direction into the second mating housing.

Here, the third held portion is positioned in a different position from the third contact portion in the first perpendicular direction of the third held portion, which is a specific direction out of directions perpendicular to the press-fitting direction of the third held portion, and has a range overlapping the third contact portion in the press-fitting direction of the third held portion.

For this reason, compared with an aspect where the third held portion does not have a range overlapping the third contact portion in the press-fitting direction of the third held portion, the dimension of the third held portion in the press-fitting direction can be increased while preventing an increase in the size of the second connector in the press-fitting direction of the third held portion, and the attitude of the third terminal relative to the second mating housing can be stabilized.

A connector pair pertaining to an eighteenth aspect is the seventeenth aspect, wherein the first connector includes a second terminal, the second terminal includes a second held portion that is held in the first mating housing, a second contact portion that electrically contacts the connection target, and a second coupling portion that couples the second held portion and the second contact portion to each other, the second held portion is held in the first mating housing as a result of being press-fitted in a predetermined press-fitting direction into the first mating housing, the press-fitting direction of the second held portion is parallel to the press-fitting direction of the first held portion, the second held portion does not have a range overlapping the second contact portion in the press-fitting direction of the second held portion, the second connector includes a fourth terminal, the fourth terminal includes a fourth held portion that is held in the second mating housing, a fourth contact portion that electrically contacts the second terminal, and a fourth coupling portion that couples the fourth held portion and the fourth contact portion to each other, the fourth held portion is held in the second mating housing as a result of being press-fitted in a predetermined press-fitting direction into the second mating housing, and the fourth held portion does not have a range overlapping the fourth contact portion in the press-fitting direction of the fourth held portion.

In this aspect, the first connector includes the second terminal. The second terminal includes the second held portion that is held in the first mating housing, the second contact portion that electrically contacts the connection target, and the second coupling portion that couples the second held portion and the second contact portion to each other. The second held portion is held in the first mating housing as a result of being press-fitted in a predetermined press-fitting direction into the first mating housing. The press-fitting direction of the second held portion is parallel to the press-fitting direction of the first held portion.

Here, the second held portion does not have a range overlapping the second contact portion in the press-fitting direction of the second held portion.

For this reason, the electrical path resulting from the second terminal is easily made into a path with few detours. As a result, the first connector suitable for when the second terminal is used as a signal terminal can be realized.

Furthermore, in this aspect, the second connector includes the fourth terminal. The fourth terminal includes the fourth held portion that is held in the second mating housing, the fourth contact portion that electrically contacts the second terminal, and the fourth coupling portion that couples the fourth held portion and the fourth contact portion to each other. The fourth held portion is held in the second mating housing as a result of being press-fitted in a predetermined press-fitting direction into the second mating housing.

Here, the fourth held portion does not have a range overlapping the fourth contact portion in the press-fitting direction of the fourth held portion.

For this reason, the electrical path resulting from the fourth terminal is easily made into a path with few detours. As a result, the second connector suitable for when the fourth terminal is used as a signal terminal can be realized.

It will be noted that although in the embodiment described below the second held portion is positioned in the same position as the second contact portion in directions (two directions) perpendicular to the press-fitting direction of the second held portion, this aspect is not limited thereto.

Furthermore, although in the embodiment described below the fourth held portion is positioned in a different position from the fourth contact portion in the first perpendicular direction of the fourth held portion, which is a specific direction out of directions perpendicular to the press-fitting direction of the fourth held portion, this aspect is not limited thereto.

### BRIEF DESCRIPTION OF THE DRAWINGS

FIG. 1 is a perspective view of a connector pair in a connected state;

FIG. 2 is a perspective view of the connector pair in a state prior to connection;

FIG. 3 is an exploded perspective view of a first connector;

FIG. 4 is a perspective view of a second connector;

FIG. 5 is an exploded perspective view of the second connector;

FIG. 6 is a sectional view of the connector pair in a state prior to connection;

FIG. 7 is a sectional view of the connector pair in a connected state;

FIG. 8 is another sectional view of the connector pair in a state prior to connection;

FIG. 9 is another sectional view of the connector pair in a connected state;

FIG. 10 is a perspective view showing a plurality of first terminals;

FIG. 11 is a drawing of a first terminal as viewed from one side in a first perpendicular direction;

FIG. 12 is a drawing of the first terminal as viewed from the other side in a second perpendicular direction;

FIG. 13 is a perspective view showing a plurality of third terminals;

FIG. 14 is an enlarged sectional view of the first connector;

FIG. 15 is a sectional perspective view showing part of the first connector;

FIG. 16 is another sectional perspective view showing part of the first connector (with the first terminals omitted);

FIG. 17 is another sectional perspective view showing part of the first connector;

FIG. 18A is a perspective view showing the first connector of the embodiment;

FIG. 18B is a perspective view showing a first connector of an example modification;

FIG. 19A is a perspective view showing the third terminal of the embodiment;

FIG. 19B is a perspective view showing a third terminal of an example modification;

FIG. 20A is a sectional view of the connector pair of the embodiment; and

FIG. 20B is a sectional view of a connector pair of an example modification.

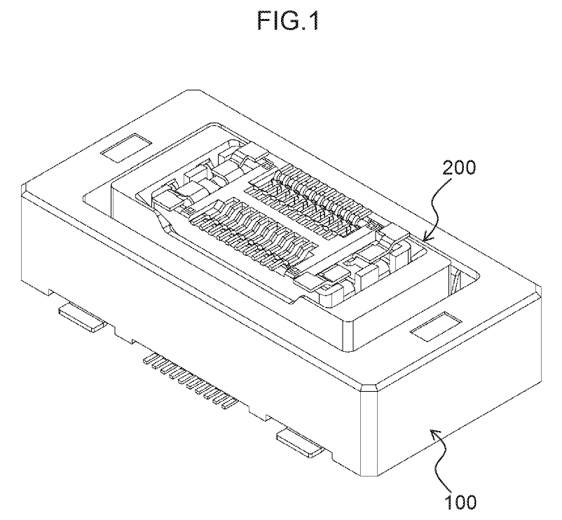

### DETAILED DESCRIPTION

A preferred embodiment of this disclosure will be described below.

A connector pair 100, 200 includes a first connector 100 and a second connector 200. The second connector 200 may be called a connection target 200.

The first connector 100 is attached to a first attachment target 91, and the second connector 200 is attached to a second attachment target 92. The connector pair 100, 200 electrically interconnects the first attachment target 91 and the second attachment target 92. The first attachment target 91 is a first circuit board, and the second attachment target 92 is a second circuit board. The first circuit board and the second circuit board are disposed parallel to each other.

The first connector 100 and the second connector 200 are connected to each other so that the upward directions of the connectors oppose each other. In other words, in a state in which the first connector 100 and the second connector 200 are connected to each other, the upward direction of the first connector 100 and the upward direction of the second connector 200 are exact opposite directions. Furthermore, in what follows, directions that are perpendicular to the up and down direction of the connector pair 100, 200 and are perpendicular to each other will be called a front and rear direction and a width direction. When reference is made simply to the front and rear direction and the width direction, this will mean the front and rear direction and the width direction of the connector pair 100, 200 or each of the connectors 100, 200.

### First Connector 100

The first connector 100 includes a plurality of first terminals 10 that are used as power terminals, a plurality of second terminals 20 that are used as signal terminals, a first fixed housing 60 that is fixed to the first attachment target 91, and a first mating housing 50 that is configured to be movable relative to the first attachment target 91 and mates with the connection target 200.

### First Terminals 10

The first terminals 10 each include a first connection portion 11 that is connected to the first attachment target 91, a mating-side first held portion 14 that is held in the first mating housing 50, a fixed-side first held portion 12 that is held in the first fixed housing 60, a first spring portion 13 that is provided between the mating-side first held portion 14 and the fixed-side first held portion 12, a first contact portion 16 that electrically contacts the connection target 200, and a first coupling portion 15 that couples the mating-side first held portion 14 and the first contact portion 16 to each other.

The thickness direction of the first connection portion 11 faces a direction perpendicular to the face of the first circuit board 91 serving as the first attachment target 91.

The mating-side first held portion 14 is held in the first mating housing 50 as a result of being press-fitted in a predetermined press-fitting direction (the upward direction of the first connector 100) into the first mating housing 50. Directions perpendicular to the press-fitting direction of the mating-side first held portion 14 and perpendicular to each other will be called a first perpendicular direction and a second perpendicular direction of the mating-side first held portion 14. The mating-side first held portion 14 extends in the press-fitting direction. The thickness direction of the mating-side first held portion 14 is parallel to the first perpendicular direction. The width direction of the mating-side first held portion 14 is parallel to the second perpendicular direction. The press-fitting direction, the first perpendicular direction, and the second perpendicular direction of the mating-side first held portion 14 are directional concepts based on each mating-side first held portion 14.

The first terminal 10 is disposed so that the first perpendicular direction of the mating-side held portion 14 faces the same direction as inward in the front and rear direction of the first connector 100 and so that the second perpendicular direction of the mating-side first held portion 14 faces the same direction as outward in the width direction of the first connector 100.

The fixed-side first held portion 12 is held in the first fixed housing 60 as a result of being press-fitted in a predetermined press-fitting direction (the upward direction of the first connector 100) into the first fixed housing 60. The thickness direction of the fixed-side first held portion 12 is parallel to the second perpendicular direction of the mating-side first held portion 14. The width direction of the fixed-side first held portion 12 is parallel to the first perpendicular direction of the mating-side first held portion 14. The fixed-side first held portion 12 is positioned on the second perpendicular direction side (one side in the second perpendicular direction) relative to the mating-side first held portion 14.

The first spring portion 13 includes a first turn-back portion 13a, where the extension direction of the first terminal 10 turns back in the up and down direction, and a second turn-back portion 13b, where the extension direction of the first terminal 10 turns back in the up and down direction. The first spring portion 13 is formed bent so that its thickness direction changes in a plane perpendicular to the first perpendicular direction of the mating-side first held portion 14.

The first terminal 10 includes a thickness direction changing portion 17 positioned between the first spring portion 13 and the mating-side first held portion 14. The thickness direction changing portion 17 changes the thickness direction of the first terminal 10 between the first spring portion 13, where the thickness direction faces an in-plane direction perpendicular to the first perpendicular direction, and the mating-side first held portion 14, where the thickness direction faces the first perpendicular direction.

The first contact portion 16 has a tabular shape. The thickness direction of the first contact portion 16 is parallel to the first perpendicular direction. The first contact portion 16 is configured so that the connection target 200 contacts the first contact portion 16 from one thickness direction side of the first contact portion 16. The width direction of the first contact portion 16 is parallel to the second perpendicular direction. The shape of the first contact portion 16 is a shape whose lengthwise direction coincides with the press-fitting direction. The shape of the first contact portion 16 specifically is a substantially rectangular shape whose lengthwise direction coincides with the press-fitting direction and whose widthwise direction coincides with the second perpendicular direction.

The first contact portion 16 is positioned on one side in the first perpendicular direction relative to the mating-side first held portion 14. The position of the first contact portion 16 coincides with that of the mating-side first held portion 14 in the second perpendicular direction.

The first coupling portion 15 is configured so that the extension direction of the first terminal 10 turns back in the up and down direction at it. The first coupling portion 15 couples the end on the press-fitting direction side (upper side) of the mating-side first held portion 14 and the end on the press-fitting direction side (upper side) of the first contact portion 16 to each other. The first coupling portion 15 includes a bent portion 15a that is bent in the thickness direction, a linear portion 15b, and a bent portion 15c that is bent in the thickness direction.

The first coupling portion 15 is positioned more upward than the first contact portion 16. Because of this, the first coupling portion 15 is configured to contact the connection target 200 (specifically a third contact portion 36 of a third terminal 30) before the first contact portion 16 does when the first connector 100 and the connection target 200 are connected to each other. As a result, the first coupling portion 15 functions as a part that guides the part of the connection target 200 (the third contact portion 36 of the third terminal 30) that contacts the first contact portion 16 when the first connector 100 and the connection target 200 are connected to each other.

The width dimension of the first coupling portion 15 is smaller than the width dimension of the mating-side first held portion 14 and smaller than the width dimension of the first contact portion 16.

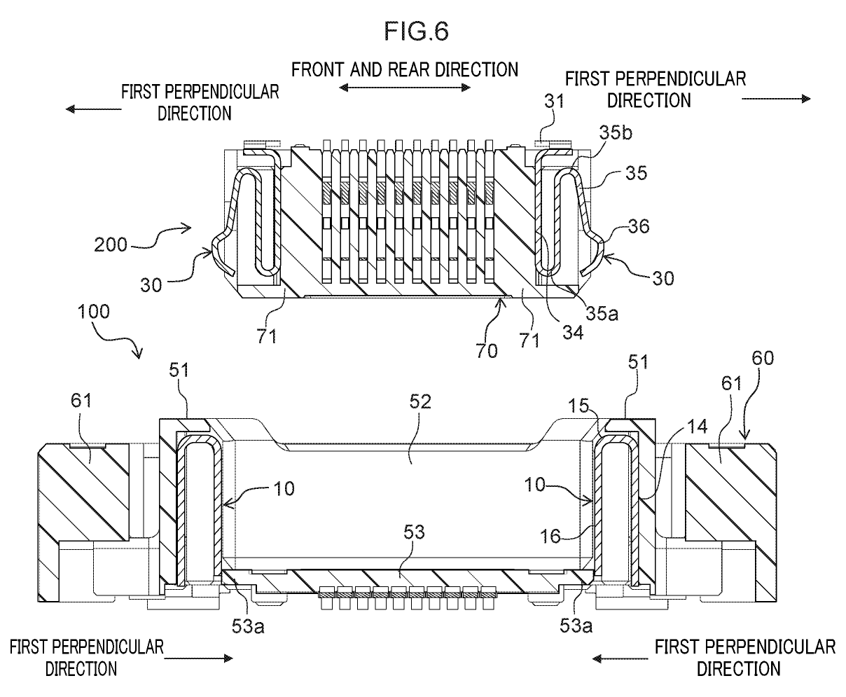

As shown in FIG. 6, the mating-side first held portion 14 is positioned in a different position from the first contact portion 16 in the first perpendicular direction of the mating-side first held portion 14. Specifically, the first contact portion 16 is positioned on the first perpendicular direction side (one side in the first perpendicular direction, inward in the front and rear direction) relative to the mating-side first held portion 14.

The mating-side first held portion 14 has a range overlapping the first contact portion 16 in the press-fitting direction of the mating-side first held portion 14.

### Second Terminals 20

The second terminals 20 each include a second connection portion 21 that is connected to the first attachment target 91, a mating-side second held portion 24 that is held in the first mating housing 50, a fixed-side second held portion 22 that is held in the first fixed housing 60, a second spring portion 23 that is provided between the mating-side second held portion 24 and the fixed-side second held portion 22, a second contact portion 26 that electrically contacts the connection target 200, and a second coupling portion 25 that couples the mating-side second held portion 24 and the second contact portion 26 to each other.

The thickness direction of the second connection portion 21 faces a direction perpendicular to the face of the first circuit board 91 serving as the first attachment target 91.

The mating-side second held portion 24 is held in the first mating housing 50 as a result of being press-fitted in a predetermined press-fitting direction (the upward direction of the first connector 100) into the first mating housing 50. The press-fitting direction of the mating-side second held portion 24 is parallel to the press-fitting direction of the mating-side first held portion 14 and specifically is the same direction as the press-fitting direction of the mating-side first held portion 14. Directions that are perpendicular to the press-fitting direction of the mating-side second held portion 24 and are perpendicular to each other will be called a first perpendicular direction and a second perpendicular direction of the mating-side second held portion 24. The mating-side second held portion 24 extends in the press-fitting direction. The thickness direction of the mating-side second held portion 24 is parallel to the first perpendicular direction. The width direction of the mating-side second held portion 24 is parallel to the second perpendicular direction. The press-fitting direction, the first perpendicular direction, and the second perpendicular direction of the mating-side second held portion 24 are directional concepts based on each mating-side second held portion 24.

The mating-side second held portion 24, the second coupling portion 25, and the second contact portion 26 are lined up on a same straight line extending parallel to the up and down direction of the first connector 100. Consequently, the mating-side second held portion 24 is positioned in the same position as the second contact portion 26 in a direction (the first perpendicular direction and the second perpendicular direction) perpendicular to the press-fitting direction of the mating-side second held portion 24. The mating-side second held portion 24 does not have a range overlapping the second contact portion 26 in the press-fitting direction of the mating-side second held portion 24.

The thickness of the second terminal 20 is smaller than the thickness of the first terminal 10. Specifically, the second terminal 20 is made of a material with a smaller thickness than the material of the first terminal 10.

### First Mating Housing 50

The first mating housing 50 includes a pair of first holding portions 51 that hold the mating-side first held portions 14 of the first terminals 10.

The pair of first holding portions 51 are a pair of width direction wall portions 51 that extend in the width direction of the first connector 100. Furthermore, the first mating housing 50 includes a pair of front and rear direction wall portions 52 that extend in the front and rear direction of the first connector 100. The pair of front and rear direction wall portions 52, together with the pair of width direction wall portions 51, form a tubular portion 51, 52. Moreover, the first mating housing 50 includes a bottom wall portion 53.

The first holding portions 51 each have first housing spaces 51S that open inward in the front and rear direction. Two first housing spaces 51S apiece are formed in each first holding portion 51. The first housing spaces 51S also open to the lower side of the first connector 100. The first housing spaces 51S house the mating-side first held portions 14, the first coupling portions 15, and the first contact portions 16. The mating-side first held portions 14, the first coupling portions 15, and the first contact portions 16 are housed from below relative to the first housing spaces 51S. The first coupling portions 15 are housed in the first housing spaces 51S before the mating-side first held portions 14 and the first contact portions 16 are when the mating-side first held portions 14 are press-fitted into the first mating housing 50. The first coupling portions 15 function as parts that guide the mating-side first held portions 14 and the first contact portions 16 of the first terminals 10 to the first housing spaces 51S when the first terminals 10 are press-fitted into the first mating housing 50.

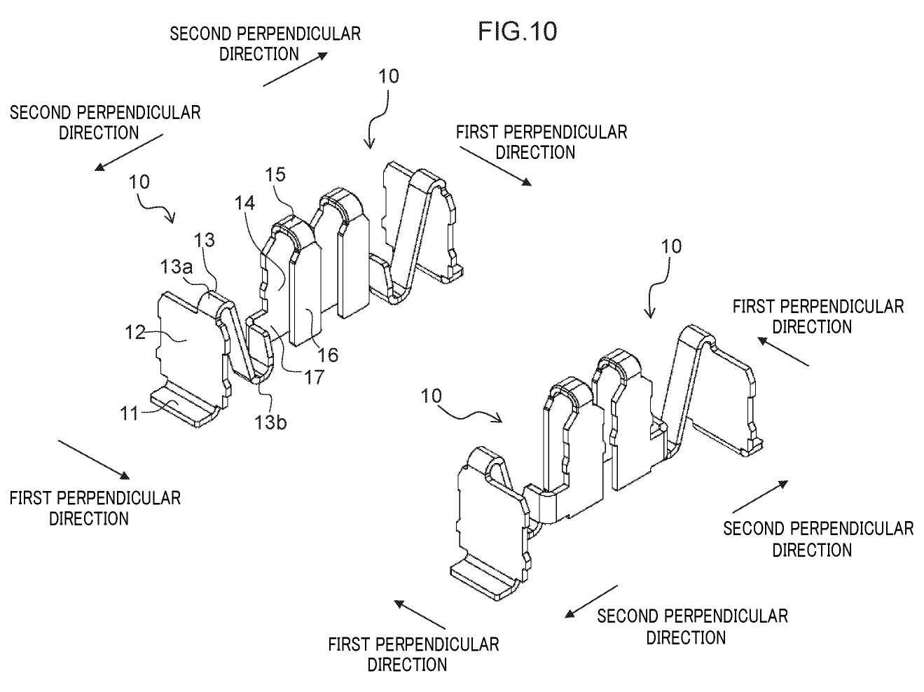

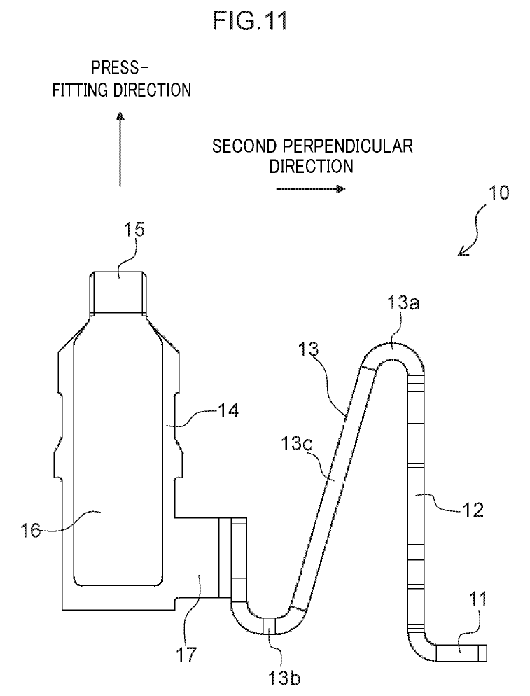

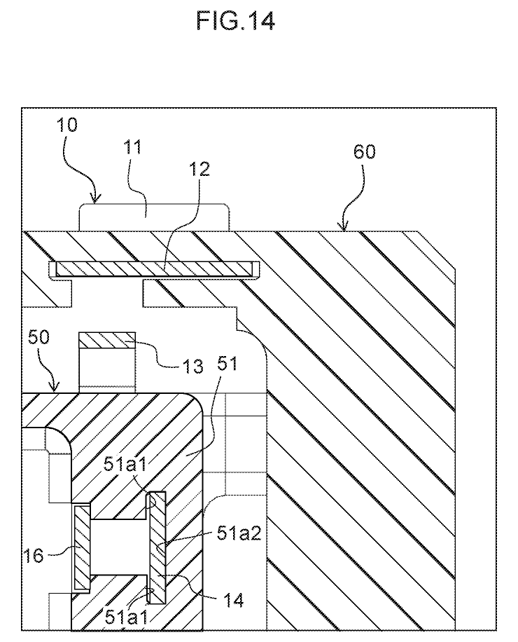

As shown in FIG. 14, the mating-side first held portions 14 are sandwiched and held in the first holding portions 51 in their width direction. Because of this, the mating-side first held portions 14 are inhibited from shifting from their appropriate positions in the width direction of the mating-side first held portions 14. Specifically, as shown in FIG. 10, the mating-side first held portions 14 have press-fitting projections (reference signs omitted) that project outward in their width direction. The press-fitting projections eat into inner wall surfaces of the first housing spaces 51S provided in the first holding portions 51.

Moreover, as shown in FIG. 14, the first holding portions 51 each include a one-side proximal surface 51a1 that is positioned proximal to one thickness direction side of the mating-side first held portion 14 and an other-side proximal surface 51a2 that is positioned proximal to the other thickness direction side of the mating-side first held portion 14. Because of this, the mating-side first held portions 14 are inhibited from shifting from their appropriate positions in the thickness direction of the mating-side first held portions 14.

In this way, the first holding portions 51 are configured to surround the mating-side first held portions 14 from four directions perpendicular to the press-fitting direction. In other words, the mating-side first held portions 14 are surrounded by the walls of the first mating housing 50 so that they do not shift positions in their width direction and their thickness direction. The surrounded regions are formed in a range that is long along the press-fitting direction.

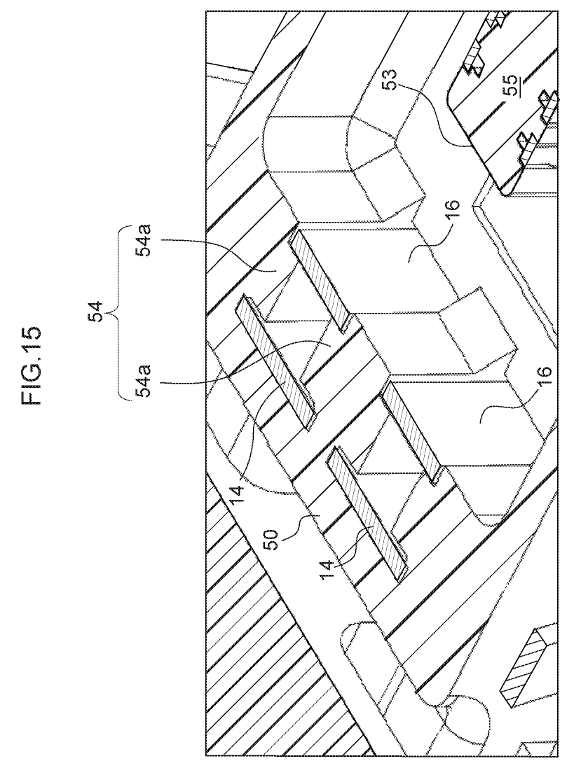

As shown in FIG. 15, the first mating housing 50 includes regulating portions 54 that regulate the first contact portions 16 from being displaced to the other side in the thickness direction. The regulating portions 54 are provided in the first holding portions 51.

The regulating portions 54 each include a pair of regulating walls 54a. The pair of regulating walls 54aregulate the first contact portion 16 from being displaced to the other side in the thickness direction by contacting both width direction end portions of the first contact portion 16. The space between the pair of regulating walls 54ais a space through which the first coupling portion 15 passes when the mating-side first held portion 14 is press-fitted into the first mating housing 50. In a state in which the first contact portion 16 is in contact with the pair of regulating walls 54a, the surface on the one thickness direction side of the first contact portion 16 does not project inward in the front and rear direction from the front and rear direction inner surface of the first holding portion 51 (the width direction wall portion 51).

The first connector 100 includes springback prevention portions 53a that prevent springback of the bent portions 15a and the bent portions 15c of the first coupling portions 15 by contacting the first contact portions 16.

The springback prevention portions 53a are provided as part of the bottom wall portion 53. The springback prevention portions 53acontact lower end portions of the first contact portions 16.

The first mating housing 50 includes a central wall portion 55 on which the second contact portions 26 of the second terminals 20 are disposed.

The central wall portion 55 is provided inside the tubular portion 51, 52 and extends in the front and rear direction. The central wall portion 55 projects upward from the bottom wall portion 53.

On a surface on one side in the width direction of the central wall portion 55, the second contact portions 26 of the second terminals 20 on one side are disposed, and on the surface on the other side in the width direction of the central wall portion 55, the second contact portions 26 of the second terminals 20 on the other side are disposed.

The central wall portion 55 regulates the second contact portions 26 of the second terminals 20 from being displaced inward in the width direction.

The central wall portion 55 has grooves (reference signs omitted) that regulate the second contact portions 26 of the second terminals 20 from being displaced in the front and rear direction.

The first mating housing 50 includes a plurality of projecting portions 56 for limiting movement of the first mating housing 50 in the up and down direction. The projecting portions 56 are provided so as to project outward in the front and rear direction from the width direction wall portions 51.

### First Fixed Housing 60

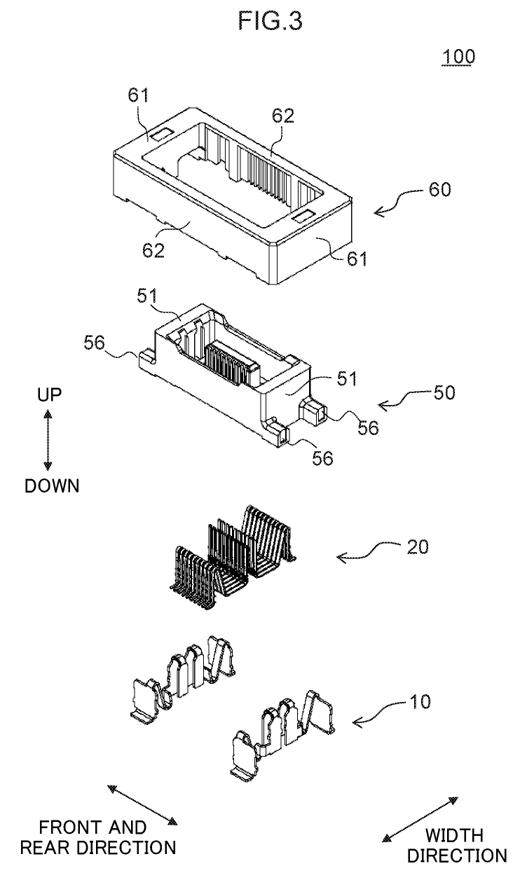

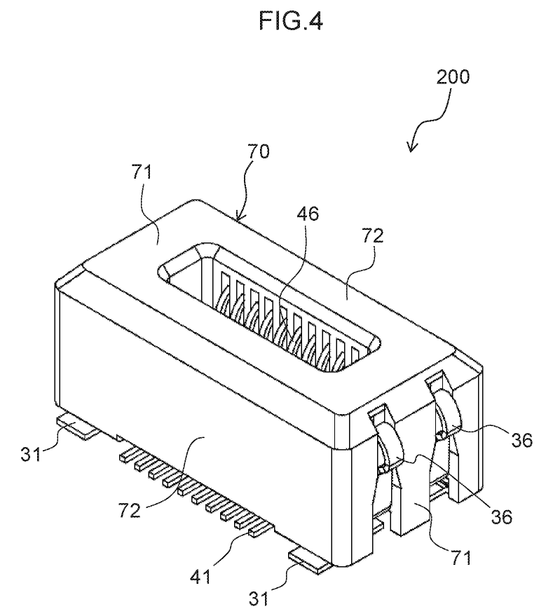

As shown in FIG. 3, the first fixed housing 60 includes a pair of width direction wall portions 61 that extend in the width direction and a pair of front and rear direction wall portions 62 that extend in the front and rear direction.

The width direction wall portions 61 function to limit movement of the first mating housing 50 in the up and down direction.

The front and rear direction wall portions 62 hold the fixed-side first held portions 12 of the first terminals 10 and hold the fixed-side second held portions 22 of the second terminals 20. The first connection portions 11 of the first terminals 10 project outward in the width direction from width direction outer surfaces of the front and rear direction wall portions 62 when viewed in a plan view. The second connection portions 21 of the second terminals 20 project outward in the width direction from width direction outer surfaces of the front and rear direction wall portions 62 when viewed in a plan view.

The pair of width direction wall portions 61 and the pair of front and rear direction wall portions 62 form a tubular portion 61, 62. The first mating housing 50 is disposed inside the tubular portion 61, 62.

### Second Connector 200

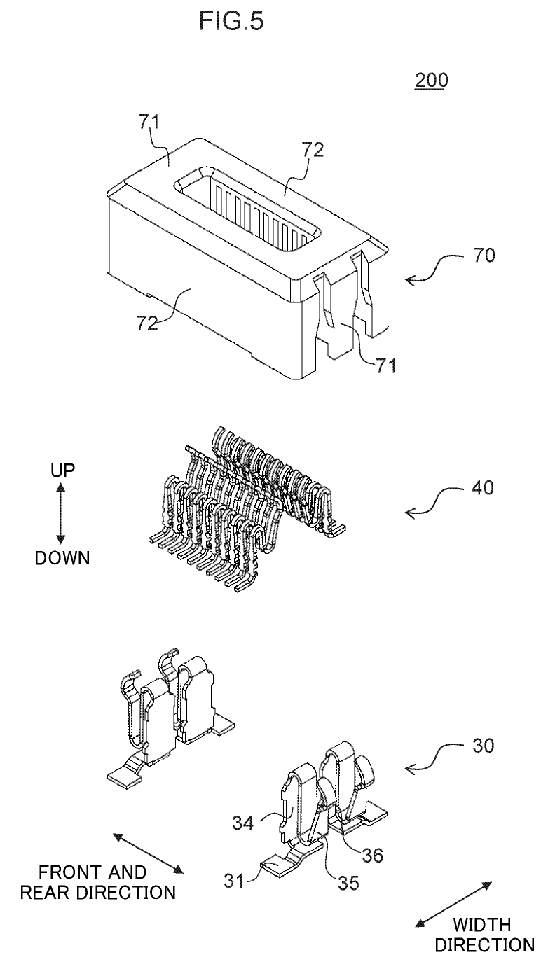

As shown in FIG. 5, the second connector 200 includes third terminals 30 that are used as power terminals, fourth terminals 40 that are used as signal terminals, and a second mating housing 70 that is fixed to the second attachment target 92 and mates with the first mating housing 50.

### Third Terminals 30

As shown in FIG. 5, the third terminals 30 each include a third connection portion that is connected to the second attachment target 92, a third held portion 34 that is held in the second mating housing 70, a third contact portion 36 that electrically contacts the first terminal 10, and a third coupling portion 35 that couples the third held portion 34 and the third contact portion 36 to each other.

The thickness direction of the third connection portion 31 faces a direction perpendicular to the face of the second circuit board 92 serving as the second attachment target 92.

The third held portion 34 is held in the second mating housing 70 as a result of being press-fitted in a predetermined press-fitting direction (the upward direction of the second connector 200) into the second mating housing 70. Directions that are perpendicular to the press-fitting direction of the third held portion 34 and are perpendicular to each other will be called a first perpendicular direction and a second perpendicular direction of the third held portion 34. The third held portion 34 extends in the press-fitting direction. The thickness direction of the third held portion 34 is parallel to the first perpendicular direction. The width direction of the third held portion 34 is parallel to the second perpendicular direction. The press-fitting direction, the first perpendicular direction, and the second perpendicular direction of the third held portion 34 are directional concepts based on each third held portion 34.

The third terminal 30 is disposed so that the first perpendicular direction of the third held portion 34 faces the same direction as outward in the front and rear direction of the second connector 200 and so that the second perpendicular direction of the third held portion 34 faces the same direction as outward in the width direction of the second connector 200.

The third contact portion 36 is configured to be elastically displaceable. The third contact portion 36 is elastically displaced to the other side in the first perpendicular direction (inward in the front and rear direction) as a result of contacting the first terminal 10.

The third coupling portion 35 elastically supports the third contact portion 36 such that the third contact portion 36 is displaceable.

The third coupling portion 35 includes a first turn-back portion 35a, where the extension direction of the third terminal 30 turns back in the up and down direction, and a second turn-back portion 35b, where the extension direction of the third terminal 30 turns back in the up and down direction. The third coupling portion 35 is formed bent in its thickness direction. The first turn-back portion 35aand the second turn-back portion 35b are formed as a result of the material of the third terminal 30 being bent in the thickness direction.

The third coupling portion 35 couples the upper end of the third held portion 34 and the lower end of the third contact portion 36 to each other.

As shown in FIG. 6, the third held portion 34 is positioned in a different position from the third contact portion 36 in the first perpendicular direction. Specifically, the third contact portion 36 is positioned on the first perpendicular direction side (one side in the first perpendicular direction, outward in the front and rear direction) relative to the third held portion 34.

The upper end of the third held portion 34 is positioned more upward than the third contact portion 36. As a result, the third held portion 34 has a range overlapping the third contact portion 36 in the press-fitting direction of the third held portion 34.

### Fourth Terminals 40

The fourth terminals 40 each include a fourth connection portion 41 that is connected to the second attachment target 92, a fourth held portion 44 that is held in the second mating housing 70, a fourth contact portion 46 that electrically contacts the second terminal 20, and a fourth coupling portion 45 that couples the fourth held portion 44 and the fourth contact portion 46 to each other.

The thickness direction of the fourth connection portion 41 faces a direction perpendicular to the face of the second circuit board 92 serving as the second attachment target 92.

The fourth held portion 44 is held in the second mating housing 70 as a result of being press-fitted in a predetermined press-fitting direction (the upward direction of the second connector 200) into the second mating housing 70. Directions that are perpendicular to the press-fitting direction of the fourth held portion 44 and are perpendicular to each other will be called a first perpendicular direction and a second perpendicular direction of the fourth held portion 44. The fourth held portion 44 extends in the press-fitting direction. The thickness direction of the fourth held portion 44 is parallel to the first perpendicular direction. The width direction of the fourth held portion 44 is parallel to the second perpendicular direction. The press-fitting direction, the first perpendicular direction, and the second perpendicular direction of the fourth held portion 44 are directional concepts based on each fourth held portion 44.

The first perpendicular direction of the fourth held portion 44 faces the same direction as inward in the width direction of the second connector 200, and the second perpendicular direction of the fourth held portion 44 faces a direction parallel to the front and rear direction of the second connector 200.

The fourth contact portion 46 is configured to be elastically displaceable. The fourth contact portion 46 is elastically displaced to the other side in the first perpendicular direction (outward in the width direction) as a result of contacting the second terminal 20.

The fourth coupling portion 45 elastically supports the fourth contact portion 46 such that the fourth contact portion 46 is displaceable.

The fourth coupling portion 45 includes a first turn-back portion 45a, where the extension direction of the fourth terminal 40 turns back in the up and down direction, and a second turn-back portion 45b, where the extension direction of the fourth terminal 40 turns back in the up and down direction. The fourth coupling portion 45 is formed bent in its thickness direction. The first turn-back portion 45aand the second turn-back portion 45b are formed as a result of the material of the fourth terminal 40 being bent in the thickness direction.

The fourth coupling portion 45 couples the upper end of the fourth held portion 44 and the lower end of the fourth contact portion 46 to each other.

The fourth held portion 44 is positioned in a different position from the fourth contact portion 46 in the first perpendicular direction. Specifically, the fourth contact portion 46 is positioned on the first perpendicular direction side (one side in the first perpendicular direction, inward in the width direction) relative to the fourth held portion 44.

The upper end of the fourth held portion 44 is positioned more downward than the fourth contact portion 46. As a result, the fourth held portion 44 does not have a range overlapping the fourth contact portion 46 in the press-fitting direction of the fourth held portion 44.

### Second Mating Housing 70

The second mating housing 70 includes a pair of width direction wall portions 71 that extend in the width direction and a pair of front and rear direction wall portions 72 that extend in the front and rear direction.

As shown in FIG. 6, the width direction wall portions 71 hold the third held portions 34 of the third terminals 30. The third contact portions 36 of the third terminals 30 are exposed from the front and rear direction outer surfaces of the width direction wall portions 71. The third connection portions 31 of the third terminals 30 project outward in the width direction from the width direction outer surfaces of the front and rear direction wall portions 72 when viewed in a plan view.

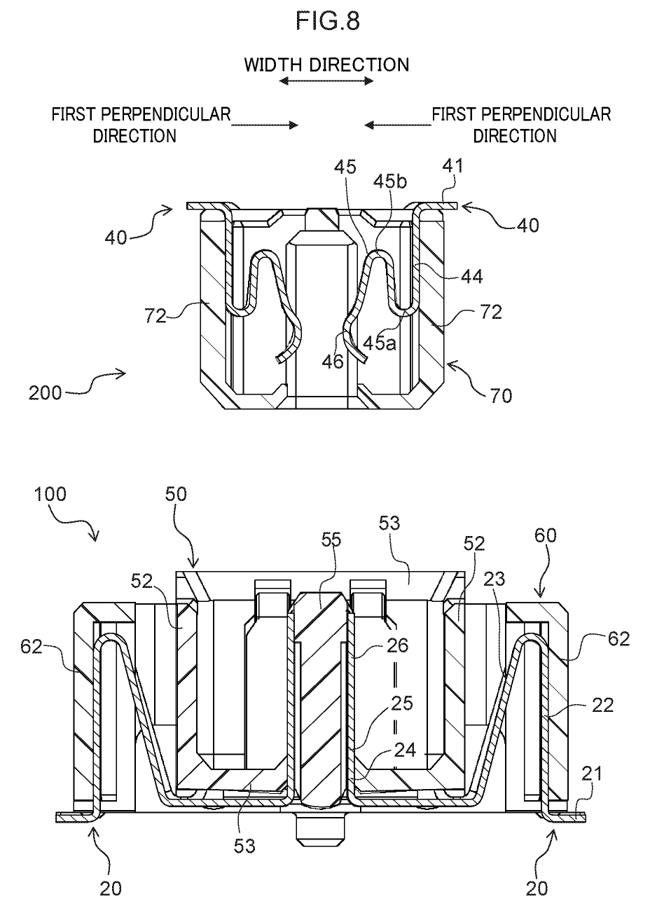

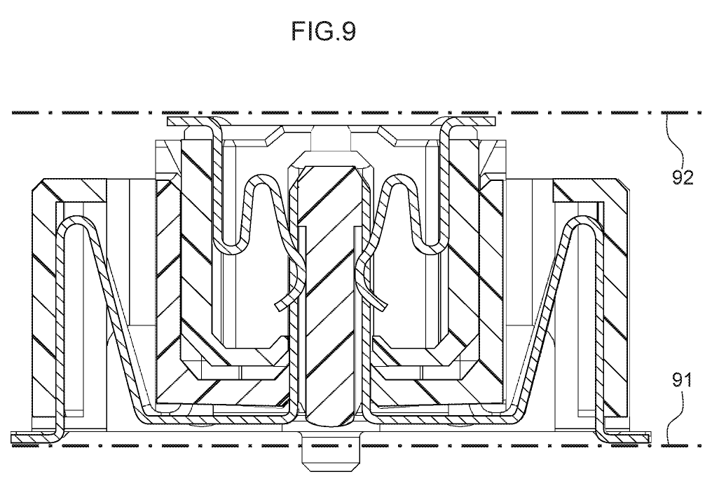

As shown in FIG. 8, the front and rear direction wall portions 72 hold the fourth held portions 44 of the fourth terminals 40. The fourth contact portions 46 of the fourth terminals 40 are exposed from the width direction inner surfaces of the front and rear direction wall portions 72. The fourth connection portions 41 of the fourth terminals 40 project outward in the width direction from the width direction outer surfaces of the front and rear direction wall portions 72 when viewed in a plan view.

### Action and Effects

Next, the action and effects of this embodiment will be described.

This embodiment relates to the first connector 100. As shown in FIG. 3, the first connector 100 includes the first mating housing 50, which mates with the connection target 200, and the first terminal 10. As shown in FIG. 10, the first terminal 10 includes the mating-side first held portion 14 that is held in the first mating housing 50, the first contact portion 16 that electrically contacts the connection target 200, and the first coupling portion 15 that couples the mating-side first held portion 14 and the first contact portion 16 to each other. The mating-side first held portion 14 is held in the first mating housing 50 as a result of being press-fitted in a predetermined press-fitting direction into the first mating housing 50.

In this connection, from the standpoint of allowing the first terminal 10 to be held in the correct attitude in the first mating housing 50, it is preferable to increase the dimension, in the press-fitting direction, of the mating-side first held portion 14 that is press-fitted into the first mating housing 50. However, if the dimension of the mating-side first held portion 14 in the press-fitting direction is increased, the dimension of the entire first connector 100 in the press-fitting direction ends up increasing.

Thus, in this embodiment, the mating-side first held portion 14 is positioned in a different position from the first contact portion 16 in the first perpendicular direction of the mating-side first held portion 14, which is a specific direction out of directions perpendicular to the press-fitting direction of the mating-side first held portion 14, and has a range overlapping the first contact portion 16 in the press-fitting direction of the mating-side first held portion 14.

For this reason, compared with an aspect where the mating-side first held portion 14 does not have a range overlapping the first contact portion 16 in the press-fitting direction of the mating-side first held portion 14 (see Japanese Patent No. 5849166), the dimension of the mating-side first held portion 14 in the press-fitting direction can be increased while preventing an increase in the size of the first connector 100 in the press-fitting direction of the mating-side first held portion 14, and the attitude of the first terminal 10 relative to the first mating housing 50 can be stabilized.

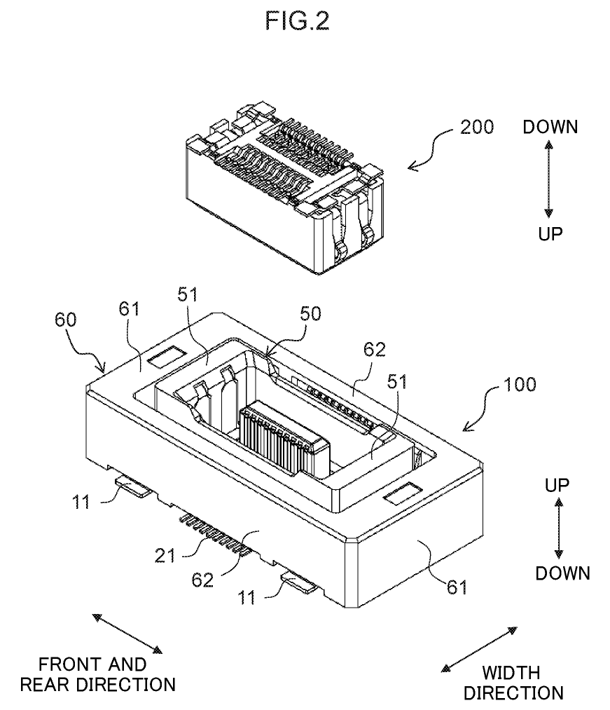

Furthermore, in this embodiment, as shown in FIG. 2, the first mating housing 50 includes the first holding portion 51 that holds the mating-side first held portion 14.

Here, as shown in FIG. 14, the first holding portion 51 includes the one-side proximal surface 51a1 that is positioned proximal to the one thickness direction side of the mating-side first held portion 14 and the other-side proximal surface 51a2 that is positioned proximal to the other thickness direction side of the mating-side first held portion 14.

For this reason, the mating-side first held portion 14 can be inhibited from shifting from its appropriate position in the thickness direction of the mating-side first held portion 14.

In this connection, if the first contact portion 16 is press-fitted into the first mating housing 50, shavings from the first mating housing 50 may stick to the first contact portion 16 and cause a conduction failure.

Thus, in this embodiment, as shown in FIG. 14, the first contact portion 16 is not press-fitted into the first mating housing 50.

For this reason, the occurrence of a conduction failure caused by shavings from the first mating housing 50 sticking to the first contact portion 16 can be inhibited.

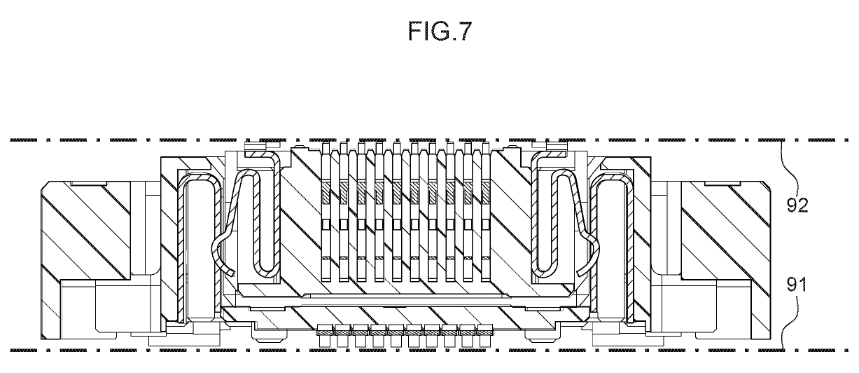

Furthermore, in this embodiment, as shown in FIG. 6 and FIG. 7, the first coupling portion 15 is configured to contact the connection target 200 before the first contact portion 16 does when the first connector 100 and the connection target 200 are connected to each other.

For this reason, the first coupling portion 15 can be made to function as a part that guides the part (the third contact portion 36) of the connection target 200 that contacts the first contact portion 16 when the first connector 100 and the connection target 200 are connected to each other.

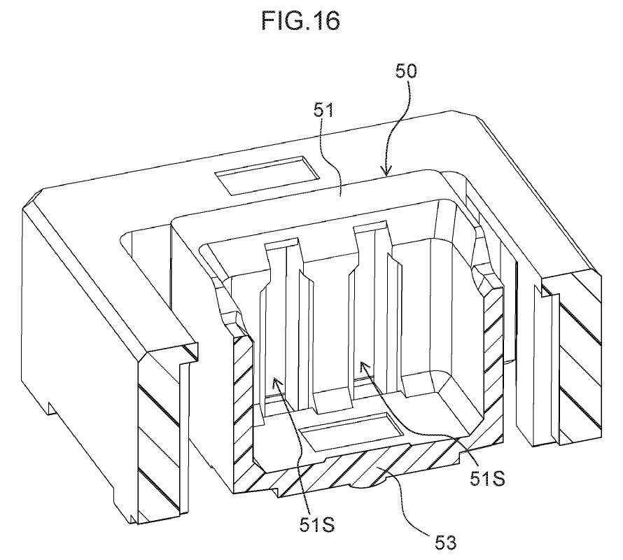

Furthermore, in this embodiment, as shown in FIG. 16, the first mating housing 50 includes the first housing space 51S that houses the mating-side first held portion 14 and the first contact portion 16.

Here, the first coupling portion 15 is configured to be housed in the first housing space 51S before the mating-side first held portion 14 and the first contact portion 16 are when the mating-side first held portion 14 is press-fitted into the first mating housing 50.

For this reason, the first coupling portion 15 can be made to function as a part that guides the mating-side first held portion 14 and the first contact portion 16 of the first terminal 10 to the first housing space 51S when the first terminal 10 is press-fitted into the first mating housing 50.

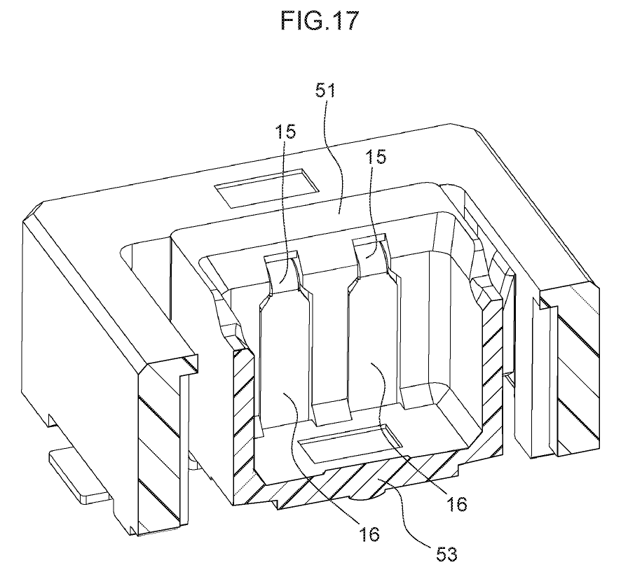

Furthermore, in this embodiment, as shown in FIG. 17, the first contact portion 16 is configured so that the connection target 200 contacts the first contact portion 16 from one thickness direction side of the first contact portion 16.

Here, as shown in FIG. 15, the first connector 100 includes the regulating portion 54 that regulates the first contact portion 16 from being displaced to the other side in the thickness direction.

For this reason, a reduction in contact pressure caused by the first contact portion 16 being displaced to the other side in the thickness direction can be inhibited.

Furthermore, in this embodiment, as shown in FIG. 15, the regulating portion 54 includes the pair of regulating walls 54a that regulate the first contact portion 16 from being displaced to the other side in the thickness direction by contacting both end width direction portions of the first contact portion 16.

For this reason, displacement of the first contact portion 16 can be reliably regulated.

Furthermore, in this embodiment, the pair of regulating walls 54a are configured so that the first coupling portion 15 can pass through the space between the pair of regulating walls 54a when the mating-side first held portion 14 is press-fitted into the first mating housing 50.

For this reason, when the mating-side first held portion 14 is press-fitted into the first mating housing 50, the first coupling portion 15 can be passed through the space between the pair of regulating walls 54a.

Furthermore, in this embodiment, as shown in FIG. 15, the first contact portion 16 is configured to not be substantially displaced.

For this reason, it is easy to control the contact pressure.

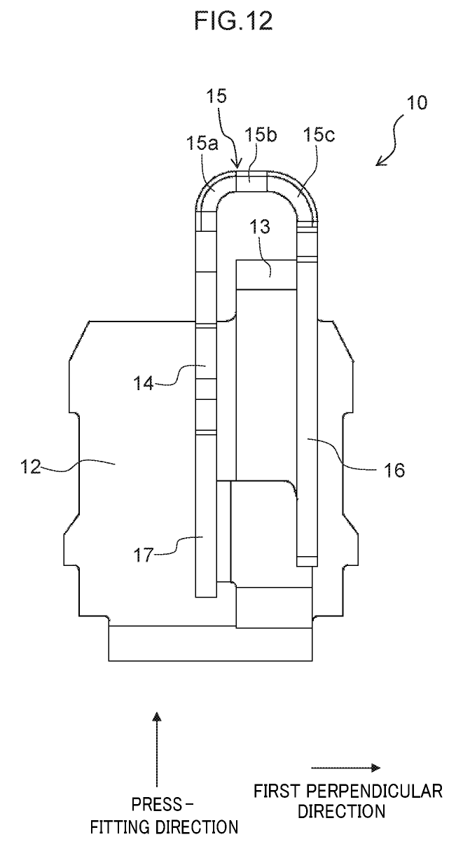

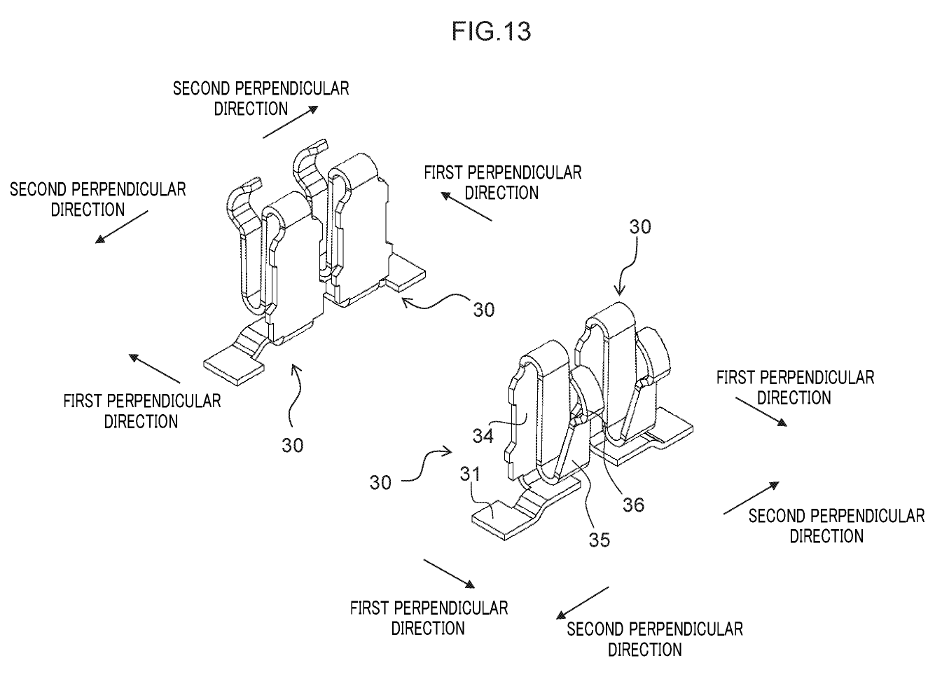

Furthermore, in this embodiment, as shown in FIG. 12, the first coupling portion 15 includes the bent portions 15a, 15c that are bent in its thickness direction.

Here, as shown in FIG. 6, the first connector 100 includes the springback prevention portions 53a that prevent springback of the bent portions 15a, 15c by contacting a part of the first terminal 10.

For this reason, springback of the bent portions 15a, 15c of the first coupling portion 15 can be prevented.

Furthermore, in this embodiment, as shown in FIG. 6, the first mating housing 50 is configured to be movable relative to the first attachment target 91 to which the first connector 100 becomes attached.

For this reason, positional shifting between the first attachment target 91 and the connection target 200 can be absorbed.

Furthermore, in this embodiment, as shown in FIG. 6, the first connector 100 includes the first fixed housing 60 that is fixed to the first attachment target 91 to which the first connector 100 becomes attached. As shown in FIG. 10, the first terminal 10 includes the mating-side first held portion 14, the fixed-side first held portion 12 that is held in the first fixed housing 60, and the first spring portion 13 that is provided between the mating-side first held portion 14 and the fixed-side first held portion 12.

Here, the fixed-side first held portion 12 has a range overlapping the first contact portion 16 in the press-fitting direction.

For this reason, compared with an aspect where the fixed-side first held portion 12 does not have a range overlapping the first contact portion 16 in the press-fitting direction, an increase in the dimension of the first connector 100 in the press-fitting direction can be prevented.

Furthermore, in this embodiment, as shown in FIG. 8, the first connector 100 includes the second terminal 20. The second terminal 20 includes the mating-side second held portion 24 that is held in the first mating housing 50, the second contact portion 26 that electrically contacts the connection target 200, and the second coupling portion 25 that couples the mating-side second held portion 24 and the second contact portion 26 to each other. The mating-side second held portion 24 is held in the first mating housing 50 as a result of being press-fitted in a predetermined press-fitting direction into the first mating housing 50. The press-fitting direction of the mating-side second held portion 24 is parallel to the press-fitting direction of the mating-side first held portion 14.

Here, the mating-side second held portion 24 is positioned in the same position as the second contact portion 26 in a direction perpendicular to the press-fitting direction of the mating-side second held portion 24 and does not have a range overlapping the second contact portion 26 in the press-fitting direction of the mating-side second held portion 24.

For this reason, the electrical path resulting from the second terminal 20 is easily made into a path with few detours. As a result, the first connector 100 suitable for when the second terminal 20 is used as a signal terminal can be realized.

Furthermore, in this embodiment, the thickness of the first terminal 10 is greater than the thickness of the second terminal 20.

For this reason, the first connector 100 suitable for when the first terminal 10 is used as a power terminal can be realized.

Furthermore, this embodiment relates to the connector pair 100, 200 that includes the first connector 100 and the second connector 200 serving as the connection target 200.

Furthermore, in this embodiment, as shown in FIG. 6, the second connector 200 includes the second mating housing 70, which mates with the first mating housing 50, and the third terminal 30. The third terminal 30 includes the third held portion 34 that is held in the second mating housing 70, the third contact portion 36 that electrically contacts the first terminal 10, and the third coupling portion 35 that couples the third held portion 34 and the third contact portion 36 to each other. The third held portion 34 is held in the second mating housing 70 as a result of being press-fitted in the predetermined press-fitting direction into the second mating housing 70.

Here, as shown in FIG. 6, the third held portion 34 is positioned in a different position from the third contact portion 36 in the first perpendicular direction of the third held portion 34, which is a specific direction out of directions perpendicular to the press-fitting direction of the third held portion 34, and has a range overlapping the third contact portion 36 in the press-fitting direction of the third held portion 34.

For this reason, compared with an aspect where the third held portion 34 does not have a range overlapping the third contact portion 36 in the press-fitting direction of the third held portion 34, the dimension of the third held portion 34 in the press-fitting direction can be increased while preventing an increase in the size of the second connector 200 in the press-fitting direction of the third held portion 34, and the attitude of the third terminal 30 relative to the second mating housing 70 can be stabilized.

Furthermore, in this embodiment, as shown in FIG. 8, the second connector 200 includes the fourth terminal 40. The fourth terminal 40 includes the fourth held portion 44 that is held in the second mating housing 70, the fourth contact portion 46 that electrically contacts the second terminal 20, and the fourth coupling portion 45 that couples the fourth held portion 44 and the fourth contact portion 46 to each other. The fourth held portion 44 is held in the second mating housing 70 as a result of being press-fitted in a predetermined press-fitting direction into the second mating housing 70.

Here, the fourth held portion 44 does not have a range overlapping the fourth contact portion 46 in the press-fitting direction of the fourth held portion 44.

For this reason, the electrical path resulting from the fourth terminal 40 is easily made into a path with few detours. As a result, the second connector 200 suitable for when the fourth terminal 40 is used as a signal terminal can be realized.

Next, example modifications will be described.

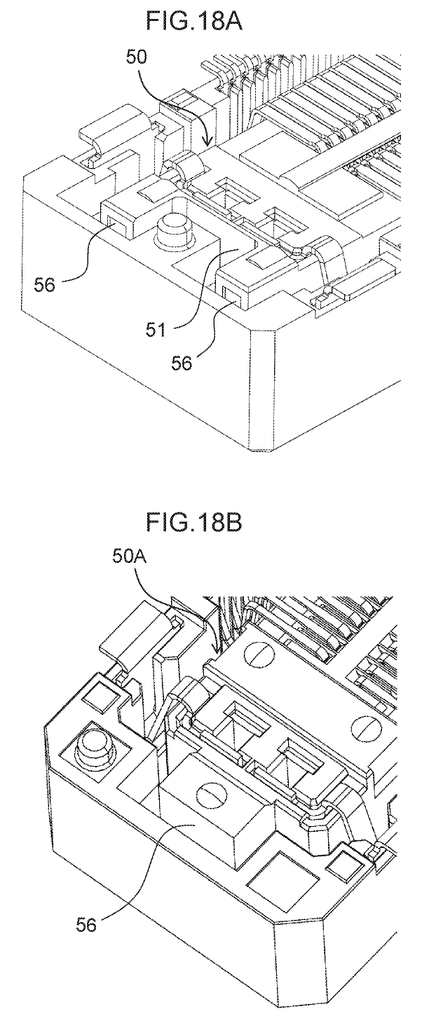

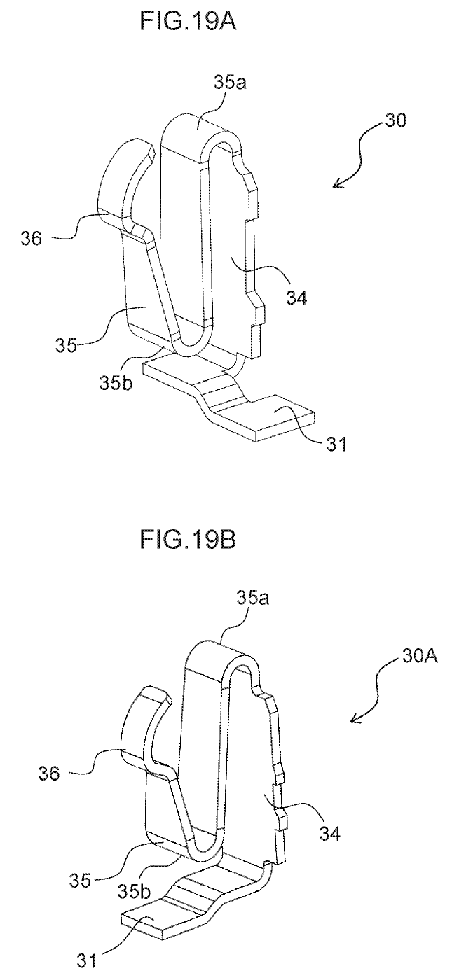

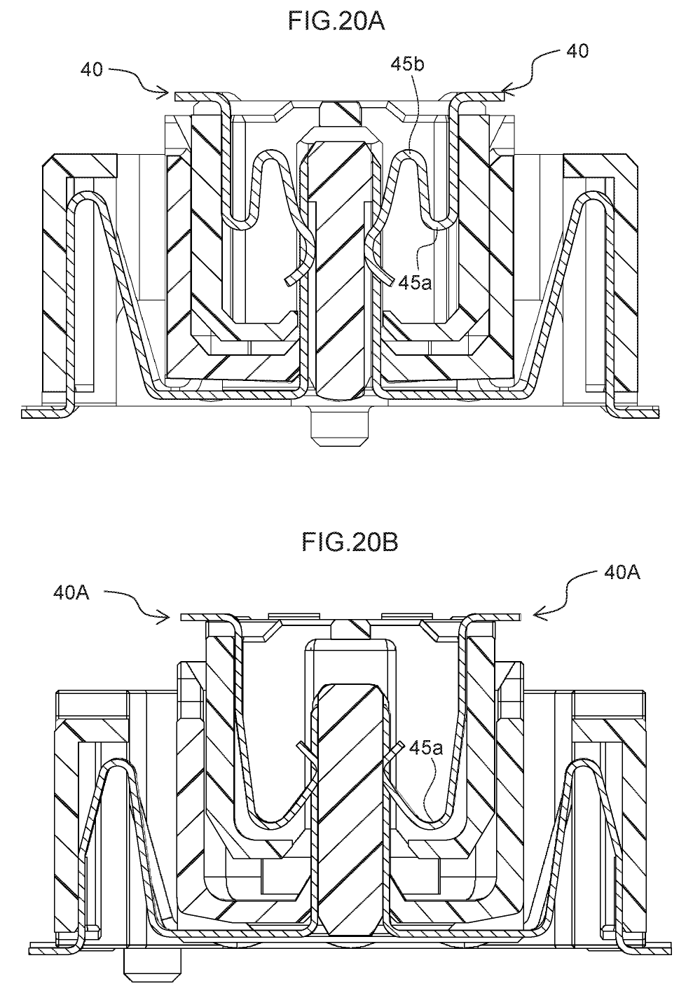

FIG. 18A, FIG. 19A, and FIG. 20A show structures of the above embodiment, and FIG. 18B, FIG. 19B, and FIG. 20B show structures of example modifications.

In this connection, sometimes marks from gates for resin molding are formed in the projecting portions 56 (projecting portions for retention) of the first mating housing 50.

As shown in FIG. 18A, in the first mating housing 50 of the above embodiment, a total of four projecting portions 56 (two on each side in the front and rear direction) are formed. However, the projecting portions 56 are small, and it is difficult to form sufficiently large gates in the parts of the mold for forming the projecting portions 56.

Thus, for example, it is conceivable that gate marks will form in the width direction wall portions 51 of the first mating housing 50. However, when gates are installed in those parts, the molten resin flowing into the mold at a high pressure forcefully collides with the parts of the mold for forming the spaces (the first housing spaces 51S) that house the first terminals 10. As a result, the mold for forming the spaces (the first housing spaces 51S) that house the first terminals 10 may be deformed or damaged.

By contrast, as shown in FIG. 18B, in a first mating housing 50A of an example modification, a total of two projecting portions 56 (one on each side in the front and rear direction) are formed. For this reason, the projecting portions 56 can be formed large, sufficiently large gates can be formed in the parts of the mold for forming the projecting portions 56, and distance between the gates and the spaces (the first housing spaces 51S) that house the first terminals 10 can be gained. For that reason, the molten resin flowing into the mold at a high pressure is less likely to forcefully collide with the parts of the mold for forming the first housing spaces 51S. As a result, the mold for forming the first housing spaces 51S is less likely to be deformed or damaged.

As shown in FIG. 19A, the third terminals 30 of the above embodiment are each formed by being bent about two axes as bending centers. For that reason, stamping is complicated.

By contrast, as shown in FIG. 19B, a third terminal 30A of an example modification is formed by being bent about one axis as a bending center. For that reason, stamping is easy.

As shown in FIG. 20A, the fourth terminals 40 of the above embodiment each have a long spring length (the length of the fourth coupling portion 45). When the length of the fourth coupling portion 45 is long, the potential for the fourth terminal 40 to buckle during connection increases.

By contrast, as shown in FIG. 20B, a fourth terminal 40A of an example modification has a shortened spring length. Specifically, the fourth coupling portion 45 of the fourth terminal 40A includes the first turn-back portion 45a but does not include the second turn-back portion 45b. For this reason, it is easy to shorten the length of the fourth coupling portion 45, and as a result, it can made difficult for the fourth terminal 40 to buckle during connection.

A preferred embodiment of the connector of this disclosure has been described above, but this disclosure is not limited thereto.

### REFERENCE SIGNS LIST

100, 200 Connector Pair

100 First Connector

200 Second Connector (Connection Target)

10 First Terminal

12 Fixed-side First Held Portion

13 First Spring Portion

14 Mating-side First Held Portion (First Held Portion)

15 First Coupling Portion

15a Bent Portion

15c Bent Portion

16 First Contact Portion

20 Second Terminal

22 Fixed-side Second Held Portion

23 Second Spring Portion

24 Mating-side Second Held Portion (Second Held Portion)

25 Second Coupling Portion

26 Second Contact Portion

30 Third Terminal

34 Third Held Portion

35 Third Coupling Portion

36 Third Contact Portion

40 Fourth Terminal

44 Fourth Held Portion

45 Fourth Coupling Portion

46 Fourth Contact Portion

50 First Mating Housing

51 Width Direction Wall Portion (First Holding Portion)

51S First Housing Space

51a1 One-side Proximal Surface

51a2 Other-side Proximal Surface

53a Springback Prevention Portion

54 Regulating Portion

54a Regulating Wall

60 First Fixed Housing

70 Second Mating Housing

91 First Circuit Board (First Attachment Target)

92 Second Circuit Board (Second Attachment Target)

What is claimed is:

1. A first connector comprising:
a first mating housing that mates with a connection target; and
a first terminal,
wherein
the first terminal includes
a first held portion that is held in the first mating housing,
a first contact portion that electrically contacts the connection target, and
a first coupling portion that couples the first held portion and the first contact portion to each other,
the first held portion is held in the first mating housing as a result of being press-fitted in a predetermined press-fitting direction into the first mating housing, and
the first held portion is positioned in a different position from the first contact portion in a first perpendicular direction of the first held portion, which is a specific direction out of directions perpendicular to the press-fitting direction of the first held portion, and has a range overlapping the first contact portion in the press-fitting direction of the first held portion.

2. The first connector of claim 1, wherein
the first mating housing includes a first holding portion that holds the first held portion, and
the first holding portion includes
a one-side proximal surface that is positioned proximal to one thickness direction side of the first held portion and
an other-side proximal surface that is positioned proximal to the other thickness direction side of the first held portion.

3. The first connector of claim 1, wherein the first contact portion is not press-fitted into the first mating housing.

4. The first connector of claim 1, wherein the first coupling portion is configured to contact the connection target before the first contact portion does when the first connector and the connection target are connected to each other.

5. The first connector of claim 1, wherein
the first mating housing includes a first housing space that houses the first held portion and the first contact portion, and
the first coupling portion is configured to be housed in the first housing space before the first held portion and the first contact portion are when the first held portion is press-fitted into the first mating housing.

6. The first connector of claim 1, wherein
the first contact portion is configured so that the connection target contacts the first contact portion from one thickness direction side of the first contact portion, and
the first connector includes a regulating portion that regulates the first contact portion from being displaced to the other side in the thickness direction.

7. The first connector of claim 6, wherein the regulating portion includes a pair of regulating walls that regulate the first contact portion from being displaced to the other side in the thickness direction by contacting both width direction end portions of the first contact portion.

8. The first connector of claim 7, wherein the pair of regulating walls are configured so that the first coupling portion can pass through a space between the pair of regulating walls when the first held portion is press-fitted into the first mating housing.

9. The first connector of claim 1, wherein
the first contact portion is not press-fitted into the first mating housing,
the first contact portion is configured so that the connection target contacts the first contact portion from one thickness direction side of the first contact portion, and
the first connector includes a regulating portion that regulates the first contact portion from being displaced to the other side in the thickness direction.

10. The first connector of claim 1, wherein the first contact portion is configured to not be substantially displaced.

11. The first connector of claim 1, wherein
the first coupling portion includes bent portions that are bent in its thickness direction, and
the first connector includes a springback prevention portion that prevents springback of the bent portions by contacting a part of the first terminal.

12. The first connector of claim 1, wherein the first mating housing is configured to be movable relative to a first attachment target to which the first connector becomes attached.

13. The first connector of claim 12, wherein
the first connector includes a first fixed housing that is fixed to the first attachment target to which the first connector becomes attached,
the first terminal includes
a mating-side first held portion serving as the first held portion,
a fixed-side first held portion that is held in the first fixed housing, and
a first spring portion that is provided between the mating-side first held portion and the fixed-side first held portion, and
the fixed-side first held portion has a range overlapping the first contact portion in the press-fitting direction.

14. The first connector of claim 1, wherein
the first connector includes a second terminal,
the second terminal includes
a second held portion that is held in the first mating housing,
a second contact portion that electrically contacts the connection target, and
a second coupling portion that couples the second held portion and the second contact portion to each other,
the second held portion is held in the first mating housing as a result of being press-fitted in a predetermined press-fitting direction into the first mating housing,
the press-fitting direction of the second held portion is parallel to the press-fitting direction of the first held portion, and
the second held portion does not have a range overlapping the second contact portion in the press-fitting direction of the second held portion.

15. The first connector of claim 14, wherein the thickness of the first terminal is greater than the thickness of the second terminal.

16. A connector pair comprising the first connector of claim 1 and a second connector serving as the connection target.

17. The connector pair of claim 16, wherein
the second connector includes
a second mating housing that mates with the first mating housing and
a third terminal,
the third terminal includes
a third held portion that is held in the second mating housing,
a third contact portion that electrically contacts the first terminal, and
a third coupling portion that couples the third held portion and the third contact portion to each other,
the third held portion is held in the second mating housing as a result of being press-fitted in a predetermined press-fitting direction into the second mating housing, and
the third held portion is positioned in a different position from the third contact portion in a first perpendicular direction of the third held portion, which is a specific direction out of directions perpendicular to the press-fitting direction of the third held portion, and has a range overlapping the third contact portion in the press-fitting direction of the third held portion.

18. The connector pair of claim 17, wherein
the first connector includes a second terminal,
the second terminal includes
a second held portion that is held in the first mating housing,
a second contact portion that electrically contacts the connection target, and
a second coupling portion that couples the second held portion and the second contact portion to each other,
the second held portion is held in the first mating housing as a result of being press-fitted in a predetermined press-fitting direction into the first mating housing,
the press-fitting direction of the second held portion is parallel to the press-fitting direction of the first held portion,
the second held portion does not have a range overlapping the second contact portion in the press-fitting direction of the second held portion,
the second connector includes a fourth terminal,
the fourth terminal includes
a fourth held portion that is held in the second mating housing,
a fourth contact portion that electrically contacts the second terminal, and
a fourth coupling portion that couples the fourth held portion and the fourth contact portion to each other,
the fourth held portion is held in the second mating housing as a result of being press-fitted in a predetermined press-fitting direction into the second mating housing, and
the fourth held portion does not have a range overlapping the fourth contact portion in the press-fitting direction of the fourth held portion.
